(19) United States
(12) Patent Application Publication
(10) Pub. No.: US 2005/0050690 A1
(43) Pub. Date: Mar. 10, 2005

(54) Anti-vibratory handle for percussive and other reciprocating tools

(76) Inventors: Remy Oddo, Rock Forest (CA); Christian Clavet, Rock Forest (CA); Gilles LeBlanc, Sullivan (CA); Sylvain Ouellette, Sullivan (CA)

Correspondence Address: FAY KAPLUN & MARCIN, LLP, 15O BROADWAY, SUITE 702, NEW YORK, NY, 10038, US

(21) Appl. No.: 10/804,344

(22) Filed: Mar. 19, 2004

(30) Foreign Application Priority Data
Mar. 19, 2003 (CA) 2,423,282

(51) Int. Cl. B43L 9/00

(52) U.S. Cl. 16/431

(57) ABSTRACT

The present invention relates to an anti-vibratory handle for installation on a tool producing vibrations, comprising a stationary portion mounted on a body of the tool, a mobile portion comprising a hand-grip member, and an articulation between the stationary and mobile portions. The articulation comprises a pivot assembly interconnecting the stationary and mobile portions, and a resilient vibration-damping assembly interposed between the stationary and mobile portions to restrict angular movement of the mobile portion on the pivot assembly about the stationary portion substantially within a given angular range. The present invention also relates to a method of installing an anti-vibratory handle on a tool producing vibrations, comprising: mounting a stationary handle portion on a body of the tool; connecting a mobile tool portion to the stationary tool portion through a pivot assembly, the mobile tool portion comprising a hand-grip member; and interposing a resilient vibration-damping assembly between the stationary and mobile tool portions to restrict angular movement of the mobile tool portion on the pivot assembly about the stationary tool portion substantially within a given angular range.

### FIELD OF THE INVENTION

The present invention relates to an anti-vibratory handle for tools producing vibrations, in particular but not exclusively percussive and other reciprocating tools. In operation, this anti-vibratory handle reduces transmission of vibrations from the tool to the hand(s) and upper limb(s) of the operator.

### BACKGROUND OF THE INVENTION

Protection of Hand

Various studies have been conducted on the effectiveness of anti-vibratory gloves:

Miwa, T; “Studies on hand protectors for portable vibrating tools, I. Measurements of the attenuation effect of porous elastic materials”; Industrial Health, 2, 95-105; 1964

Miwa, T; “Studies on hand protectors for portable vibrating tools, II. Simulation of porous elastic materials and their application to hand protectors”; Industrial Health, 2, 106-123; 1964

Miwa, T; Yoneska, Y; et Kanada, K; “Vibration isolators for portable vibrating tools, Part 4. Vibration isolation gloves”; Industrial Health, 17, 141-152; 1979

Saunders, R. L.; “Report on the testing of anti-vibration gloves”; B. C. Research, 4 pages; 1978

Voss, P.; “On the vibration isolating efficiency of gloves”; United kingdom Informal Group on Human Response to Vibration, Sep. 16-17, 1982 Paper 3.1, 9 pages;

Villon, S. J.; “Effect of gloves on the transmission of vibration to the hand” M. Sc. Dissertation, University of Southampton, 140 pages, 1982.

All of these studies have demonstrated the effectiveness of such gloves for frequencies above the 100-140 Hz range, depending on the individual wearer. Below this range, however, anti-vibratory gloves are at best ineffective or tend to enhance vibrations transmitted to the hands (at resonance frequencies ranging from 30 to 45 Hz, depending on the type of glove and on the morphology of the palm of the worker).

In the particular context of percussion drills, with a dominant frequency corresponding to the frequency of impact (about 40 Hz), this type of glove may increase the exposure of workers to vibrations.

It should be noted nevertheless, that wearing gloves prevents direct contact of the hands with cold surfaces. This is a very positive factor that may limit the appearance of symptoms related to Raynaud's syndrome.

Modification of the Handle

Numerous investigations have been conducted for the purpose of damping or insulating vibrations at the level of the handle or between the body of the percussion drill and the handle.

Among the most significant works, a Russian study in 1964 may be cited, which deals with the development of anti-vibratory handles [Paran'ko, N. M.; “Hygienic evaluation of vibration and noise damping devices for hand-operated pneumatic rock drills”; Pat. Fiziol., 4, 32-38 ; 1964]. Prototypes of handles developed in the context of this study showed effectiveness approaching a 50% reduction of vibrations, but in association with either too great an increase in weight or poor mechanical resistance.

A patent was granted to Shotwell in 1976 for an anti-vibratory handle for a portable pneumatic hammer [Shotwell D. B.; “Pneumatic percussion tool having a vibration dampened handle”. Caterpillar Tractor Co.; U.S. Pat. No. 3,968,843 issued on Jul. 13, 1976]. The invention described in U.S. Pat. No. 3,968,843 consists of a rubber element inserted between the handle and the body of the pneumatic hammer. According to this patent, an attenuation of vibrations at the frequencies of interest of the order of 17 dB may be obtained. However, no statement is made about the durability or ease of handling of the tool.

Aside from the above studies, those of Boileau [Boileau P. É.; “Les vibrations engendrées par les foreuses à béquille a la division Opémiska de Minnova”; Rapport IRSST B-027, December 1990] tested and compared two anti-vibratory handles. One of these handles was, among other things, homemade and equipped with a resilient member placed between the handle and the body of a percussion drill. And this handle provided an attenuation of the order of 20% of the vibrations transmitted to the worker.

More recently, a study conducted in 1998 by the firm Boart Longyear Inc. led to the development of a new handle [Prajapati K., Hes P.; “Reduction of hand-arm transmitted Vibration on Pneumatic Jackleg Rock Drills”, Congrès CIM, Sudbury]. Tests showed an approximately 50% attenuation of non-weighted vibration levels. This attenuation is due primarily to a decrease of high frequency (>640 Hz) vibrations. The presented spectra fail to show any attenuation at the frequency of impact defined by Boileau [Boileau P. É.; “Les vibrations engendrées par les foreuses à béquille à la division Opémiska de Minnova”; Rapport IRSST B-027, December 1990], among others, as the principal component of the weighted spectrum. The impact of the use of such a handle on the exposure of workers to vibrations thus remains minimal.

Prior Works Applied to Other Tools

Numerous studies have been conducted with the aim of reducing vibrations transmitted from chainsaws to the hands of the operator. The concept most generally used is uncoupling the chain guard and the saw handle from the moving mechanical parts (internal combustion engine and chain drive system) [Bierstecker, M.; “Vibration mount on a chainsaw”; U.S. Pat. No. 4,670,985 issued Jun. 9, 1987] [Gassen J. R.; Suchdev L. S.; “Vibration Reducing Chainsaw Handle”, U.S. Pat. No. 5,016,355 issued May 21, 1991]. Recent machines equipped with this type of suspension have greatly reduced the exposure of forestry workers to vibrations.

Various other studies have been conducted on concrete breakers. Although the source of the vibrations in concrete breakers is very similar to that observed in air-leg percussion drills, the modes of operation of the two tools are quite different. The operator must hold continuously the concrete breaker using both hands and the direction of the work is generally vertical. Also, gripping of the concrete breaker differs greatly from gripping of the air-leg percussion drill, which is used essentially for making horizontal holes. In air-leg percussion drills, the drive force is produced essentially by the air-leg and the miner intervenes mainly to make the pilot hole necessary to keep the machine on the desired axis. The solutions developed within the context of these studies are therefore not directly applicable to percussion drills. One type of solution that may be cited is the development of flexible hoop-type handles or the installation of dynamic absorbers [IRGO-Pic, Ingersoll-Rand trade mark].

### SUMMARY OF THE INVENTION

The present invention relates to an anti-vibratory handle for installation on a tool producing vibrations, comprising:

a stationary portion mounted on a body of the tool;

a mobile portion comprising a hand-grip member; and

an articulation between the stationary and mobile portions, the articulation comprising:

a pivot assembly interconnecting the stationary and mobile portions; and

a resilient vibration-damping assembly interposed between the stationary and mobile portions to restrict angular movement of the mobile portion on the pivot assembly about the stationary portion substantially within a given angular range.

The present invention also relates to a method of installing an anti-vibratory handle on a tool producing vibrations, comprising:

mounting a stationary handle portion on a body of the tool;

connecting a mobile tool portion to the stationary tool portion through a pivot assembly, the mobile tool portion comprising a hand-grip member; and

interposing a resilient vibration-damping assembly between the stationary and mobile tool portions to restrict angular movement of the mobile tool portion on the pivot assembly about the stationary tool portion substantially within a given angular range.

The foregoing and other objects, advantages and features of the present invention will become more apparent upon reading of the following non-restrictive description of an illustrative embodiment thereof, given by way of example only with reference to the accompanying drawings.

### BRIEF DESCRIPTION OF THE DRAWINGS

In the appended drawings:

FIG. 1 is a schematic illustration of the basic concept of the non-restrictive illustrative embodiment of the anti-vibratory handle according to the present invention;

FIG. 2 is an exploded view of an anti-vibratory handle according to the non-restrictive illustrative embodiment according to the present invention, adapted for a JOY™ percussion drill;

FIG. 3 is a side elevational view of a JOY™ percussion drill on which an anti-vibratory handle as illustrated in FIG. 2 has been installed;

FIG. 4 is a graph of the weighted global acceleration “versus” the frequency of vibration showing a typical spectrum obtained during laboratory tests, with a triaxial accelerometer mounted on the handle at the level of the hang-grip member and two 0.635 mm thick and 12.7 mm wide resilient members made of neoprene duro 40, with strong gripping of the hand-grip member by the worker;

FIGS. 5a is a side elevational view of a resilient member for use in the illustrative embodiment of anti-vibratory handle of FIG. 2;

FIGS. 5b is a front elevational view of the resilient member of FIG. 5a;

FIG. 6 is a graph of the acceleration “versus” the frequency of vibration showing a typical spectrum obtained during in-situ tests, with a triaxial accelerometer mounted on the handle at the level of the hand-grip member;

FIG. 7a is a schematic diagram illustrating the direction of movement of the anti-vibratory handle of FIG. 2 for a JOY™ percussion drill;

FIG. 7b is a schematic diagram showing an angle for an arm member of a mobile portion of the anti-vibratory handle according to the illustrative embodiment of the present invention, optimized for the JOY™ percussion drill;

FIG. 8a is a cross sectional, side elevational view of the anti-vibratory handle according to the non-restrictive illustrative embodiment of the present invention, optimized for the JOY™ percussion drill;

FIG. 8b is a cross sectional, top plan view of the anti-vibratory handle according to the non-restrictive illustrative embodiment of the present invention, optimized for the JOY™ percussion drill;

FIG. 9 is an exploded, three-dimensional perspective view of the anti-vibratory handle of FIGS. 8a and 8b; and

FIG. 10 is an exploded, three-dimensional perspective view of an anti-vibratory handle according to the non-restrictive illustrative embodiment of the present invention, optimized for a SECAN™ percussion drill.

### DETAILED DESCRIPTION OF THE ILLUSTRATIVE EMBODIMENT

The development of an anti-vibratory handle for tools producing vibrations, such as percussive and other reciprocating tools, may be expressed in terms of three challenges:

To develop an anti-vibratory handle effective at low frequencies (≅30 Hz), therefore involving large reciprocating movements.

To ensure the passage of the tool control (electrical, pneumatic or hydraulic control) through a suspension.

To design a system both simple and robust for use under extremely severe operating conditions, for example in underground mines.

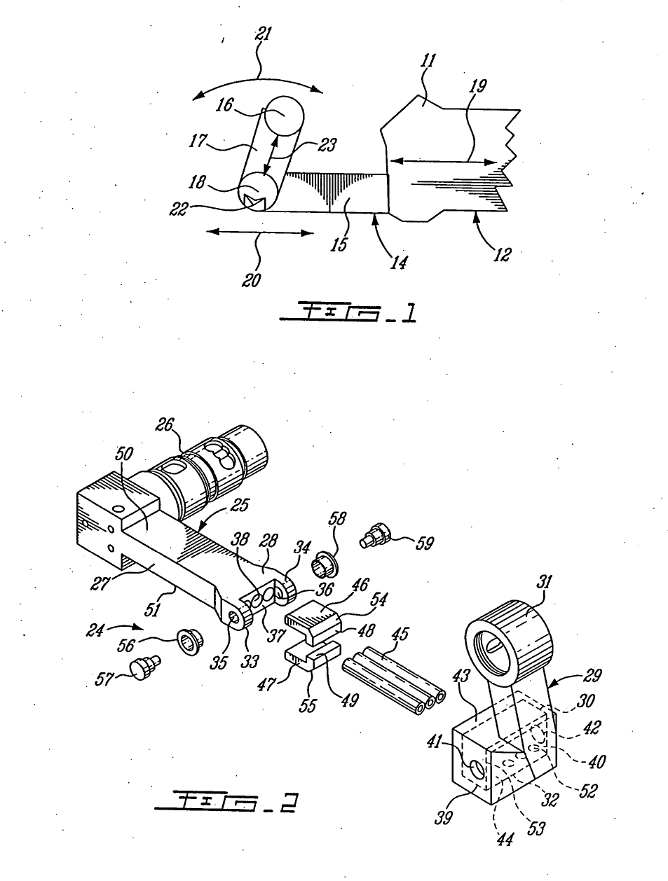

FIG. 1 illustrates the basic concept of the illustrative embodiment of the anti-vibratory handle according to the present invention, consisting of installing a pivot spaced apart from but parallel to the point of gripping of the handle.

More specifically, FIG. 1 illustrates the body 11 of a percussion drill 12. This percussion drill 12 is provided with an anti-vibratory handle 14 according to the illustrative embodiment of the present invention.

Although the preferred embodiment of the present invention will be described in relation to a percussion drill, is should be kept in mind that the present invention can be applied to other types of tools producing vibrations, in particular but not exclusively percussive and other reciprocating tools.

In accordance with the non-restrictive illustrative embodiment, the anti-vibratory handle 14 comprises at least one arm member 15 having a proximal end connected to the body 11. The anti-vibratory handle 14 also comprises a hand-grip member 16 connected to the distal end of the arm member 15 through at least one arm member 17 and an articulation 18 comprising a pivot (not shown).

Still referring to FIG. 1, the double arrows 19, 20, 21, 22 and 23 represent the nature, direction and amplitude of the main vibrations to which a percussion drill is subjected.

The double arrows 19 and 20 illustrate the vibrations of the body 11 of the drill 12 along the axis of percussion. As can be seen in FIG. 1, the hand-grip member 16 and the pivot of the articulation 18 are parallel to each other but perpendicular to the axis of percussion (see double arrows 19 and 20). According to the non-restrictive illustrative embodiment, the arm member 17, when non operating, defines with the arm member 15 an angle slightly lower than 90° about the articulation 18, of the order of, for example, 75°.

Under the influence of the back-and-forth movement (see double arrow 19 and 20 of FIG. 1) of the drill 12 along the axis of percussion, the handle 14 pivots about the articulation 18 (see double arrow 22) whereby the hand-grip member 16 moves along an arc of a circle (see double arrow 21) having a radius equivalent to the distance separating the axis of the pivot of the articulation 18 and the axis or center of inertia of the hand-grip member 16 bearing the hand(s) of the worker.

Although the attenuation of the vibrations along the axis of percussion (see double arrows 19 and 20) will produce a slight increase in vibratory movement along the longitudinal axis of the arm member 17 (see double arrow 23), the rotary concept of the anti-vibratory handle 14 affords major advantages in terms of design simplicity. In fact, it is relatively easy to obtain pure rotation. This type of movement can be achieved by means of a simple pivot supported by self-lubricating bearings. There are numerous low-cost, commercially available products for producing pure rotation.

Vibratory insulation is obtained by means of resilient members (not shown in FIG. 1) inserted within the articulation 18. These resilient members can comprise torsion insulators or pieces of resilient material inserted between jaws formed between mobile and stationary parts of the articulation 18.

For pneumatic percussion drills, the angular movement of the hand-grip member 16 about the articulation (see double arrows 21 and 22) will remain small; for example, an angular movement of ±5° (see double arrows 21 and 22) can be used for an axial displacement (see double arrow 20) of the anti-vibratory handle 14 handle of about 2 cm. With such a small angular movement, pneumatic connections under the form of flexible plastic tubes could be used without onset of material fatigue, even after a large number of bending cycles. In this manner, no complex air-tight connections are required and the structure of the articulation is thus greatly simplified to substantially reduce the costs.

FIG. 2 is an exploded view of an anti-vibratory handle according to the illustrative embodiment according to the invention, adapted for a JOY™ percussion drill. The anti-vibratory handle of FIG. 2 is generally identified by the reference 24.

The anti-vibratory handle 24 first comprises a stationary portion 25 integrated to the percussion drill (not shown) via a fixation cone 26 of the same type as those used for mounting conventional handles. Fixedly connected perpendicular to the fixation cone 26 is an arm member 27 extending in the direction of the axis of percussion. The arm member 27 comprises a pairs of opposite, longitudinal top and bottom flat faces 50 and 51. The distal end 28 of the arm member 27 forms part of the articulation 18 (FIG. 1).

The anti-vibratory handle 24 also comprises a mobile portion 29 comprising an arm member 30. The distal end of the arm member 30 is formed with a conical attachment device 31 of the type providing for direct attachment of a conventional hand-grip member (not shown) including controls for the operation of the percussion drill. This conventional hand-grip member may be identical in all respects to the existing JOY™ handle. The proximal end 32 of the arm member 30 also forms part of articulation 18 (FIG. 1). When non operating, the arm member 30 is inclined towards the stationary portion 25 to define with the axis of percussion an angle slightly lower than 90° about the articulation of the anti-vibratory handle 24, this angle being of the order of, for example, 75°.

The distal end 28 of the arm member 27 is formed with two parallel side ears 33 and 34 with respective, coaxial threaded holes 35 and 36. The distal end 28 further comprises, between the ears 33 and 34, a flat face 37 perpendicular to the longitudinal axis of the arm member 27. A series of three axial holes such as 38 are drilled through the flat face 37 between the two ears 33 and 34. These axial holes 38 are in communication with pressurized air transmitting conduits formed through the arm member 27.

The proximal end 32 of the arm member 30 has the general configuration of a hollow rectangular box-like structure with a face open toward the distal end 28 of the arm member 27. The rectangular box-like structure comprises:

a pair of opposite side walls 39 and 40 formed with respective coaxial holes 41 and 42;

a second pair of opposite top and bottom walls 43 and 44; and

an internal bottom wall 53 formed with a series of three holes 52 opposite to but corresponding to the series of three holes 38.

Again, these holes 52 are in communication with pressurized air transmitting conduits formed through the arm member 30.

The articulation 18 between the arm members 27 and 30 finally comprises three flexible tubes such as 45 of equal length and two generally flat resilient members 46 and 47 L-shaped in cross section to define respective shoulders 48 and 49. For example, the tubes 45 can be made of plastic material and the resilient members made of elastomeric material.

During installation, the following operations are performed:

The three flexible tubes 45 comprise respective first ends respectively inserted into the three holes 38.

The resilient member 46 is applied to the top flat face 50 of the arm member 27 with the shoulder 48 applied to the end flat face 37.

The resilient member 47 is applied to the bottom flat face 51 of the arm member 27 with the shoulder 49 applied to the end flat face 37.

The rectangular box-like structure of the proximal end of the arm member 30 is positioned over the distal end 28 of the arm member 27, more specifically over the ears 33 and 34 and the resilient members 46 and 47. The resilient members are bevelled at 54 and 55 to facilitate this operation. The three flexible tubes 45 comprise respective second ends respectively inserted, during this operation, into the three holes 52.

To complete the assembly, a bushing 56 made of any suitable attrition-resistant material such as bronze is inserted in hole 41, and a shoulder screw 57 is driven into the threaded hole 35 through the bushing 56. In the same manner, a bushing 58 made of any suitable attrition-resistant material such as bronze is inserted in hole 42, and a shoulder screw 59 is driven into the threaded hole 36 through the bushing 55. Therefore, the shoulder screws 57 and 59 tightened into the respective threaded holes 35 and 36 form with the bushings 56 and 58 and the holes 41 and 42 the pivot of the articulation 18 (FIG. 1).

In operation, the three tubes 45 will ensure transmission of pressurized air between the percussion drill and the control on the hand-grip member to enable control of the operation of the percussion drill by the worker. Sealing between the tubes 45 and the holes 38 and 52 is ensured by inflation of the tubes 45 when the air-leg of the percussion drill is supplied with pressurized air. As indicated in the foregoing description, with the small angular movement of, for example, ±5+ between the arm members 27 and 30, the flexible plastic tubes 45 will bend without onset of material fatigue, even after a large number of bending cycles.

Also in operation, the resilient member 46 is compressed between the top flat face 50 of the arm member 27 and the inner face of the top wall 43, while the resilient member 47 is compressed between the bottom flat face 51 of the arm member 27 and the inner face of the top bottom wall 44. During small angular movements of the arm member 30 about the arm member 27, the stiffness of the resilient, for example elastomeric members 46 and 47 is linear. If the amplitude of the angular movements increases, the greater compression of the members 46 and 47 considerably increases their stiffness. Thanks to their non linear behaviour, the resilient members 46 and 47 thus act both as vibration-damping insulators and flexible cushions intended to limit the angular movements of the arm member 30 about the arm member 27 for example to the above mentioned angular value of ±5°.

The shoulders 48 and 49 of the resilient members 46 and 47, located between the end flat face 37 and the internal bottom wall 53, retain the resilient members 46 and 47 in position between the top flat face 50 of the arm member 27 and the inner face of the top wall 43 and between the bottom flat face 51 of the arm member 27 and the inner face of the top bottom wall 44, respectively.

This anti-vibratory handle 24 of FIG. 2 provides an effective and relatively simple suspension. This suspension may be very readily adapted to existing percussion drill, since the attachment cones on the arm members 27 and 30 can be identical to those of conventional handle models.

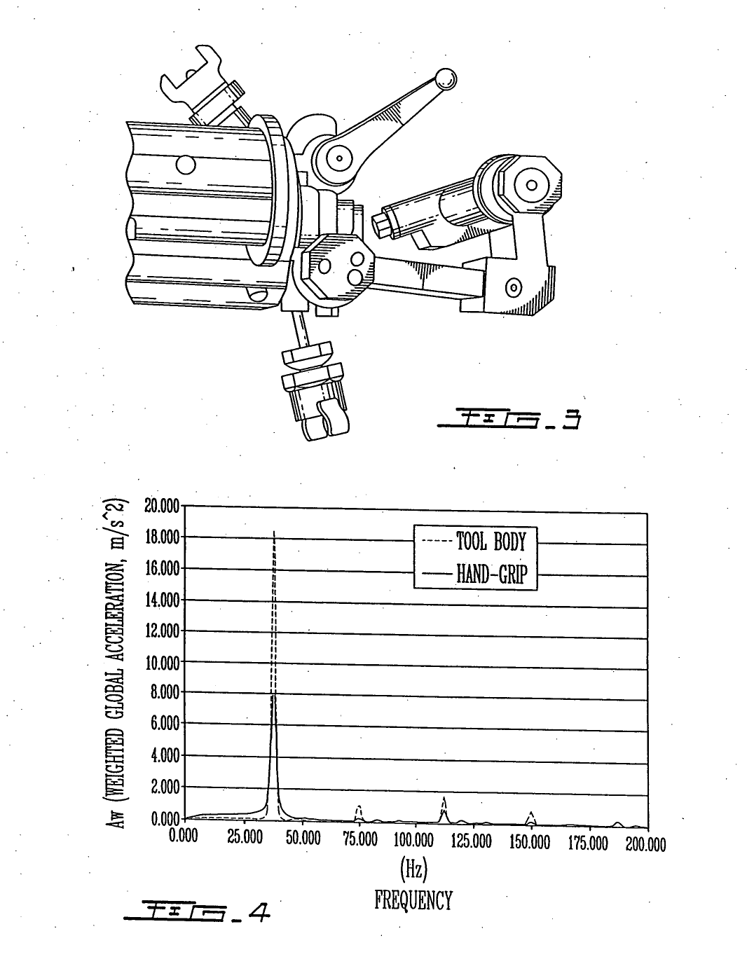

FIG. 3 illustrates the anti-vibratory handle 24 of FIG. 2 installed on a JOY™ percussion drill. The hand-grip portion of the handle remains at exactly the same height as on a conventional model, thus allowing access for the replacement of water tubes. Likewise, the worker finds the controls at exactly the same location as on the conventional handles.

Laboratory tests were conducted to demonstrate the efficiency of the anti-vibratory handle according to the illustrative embodiment of the present invention. For that purpose, a prototype of the anti-vibratory handle was built, and installed and tested on a vibrating table. All the measurements were made through a triaxial accelerometer mounted at the level of the hand-grip member of the anti-vibratory handle. Of course the accelerometer was connected to a measurement system.

A typical spectrum as obtained during the laboratory tests, with a triaxial accelerometer mounted on the handle at the level of the hand-grip member is illustrated in FIG. 4. The graph of FIG. 4 shows that an overall measured attenuation greater than 50% was obtained with two 0.635 mm thick and 12.7 mm wide resilient members made of neoprene duro 40, with strong gripping by the worker.

Various laboratory tests were conducted on a series of resilient members in order to validate the influence of parameters such as shape, applied gripping force and attachment of the resilient members. Resilient members made of various materials were tested, even though the constraints of resistance to lubricants and other external chemical agents required by trade specifications limit the choice of resilient members to polyurethane.

Effect of Gripping Force:

An initial series of laboratory tests examined the effect of the hand on the anti-vibratory insulation provided by the handle. As expected, insulation increased directly with gripping force. Thus for rubber insulators 12.7 mm wide, attenuation in weighted values passed from 45% to 68% by increasing gripping force. Similarly, a polyurethane insulator 25 mm wide brought an increase of nearly 10% in free vibrations while an insulation of about 25% was obtained by applying a gripping force.

Effect of the Type of Elastomer Attachment:

Series of tests were carried out in which resilient members were glued to the stationary and mobile parts of the anti-vibratory handle according to the illustrative embodiment of the present invention. The purpose of these tests was to simulate the use of resilient members vulcanized to the handle. The results revealed that gluing strongly decreases the anti-vibratory efficiency of the handle. The overall levels measured for the same resilient members either glued or simply inserted may vary up to two-fold. This is due mainly to the glued resilient members working as much in the compression as in the stretching mode whereas the non-glued resilient members work only in the compression mode. The choice naturally turned towards freely inserted resilient members; in this manner, the problems of gluing the resilient members was avoided and a more resilient and efficient suspension was obtained.

Effect of the Shape of the Resilient Members:

The stiffness of the resilient members is determined in part by the type of material and also by its shape. When, for example, an elastomer is compressed in a single direction, it tends to expand in the other directions (Poisson effect). If this expansion movement is restricted, the resilient member stiffens considerably. A resilient member confined laterally by rigid walls will thus stiffen upon compression. Similarly, for a given contact surface, a resilient member made of two sections will be more resilient than a resilient member made of a single piece.

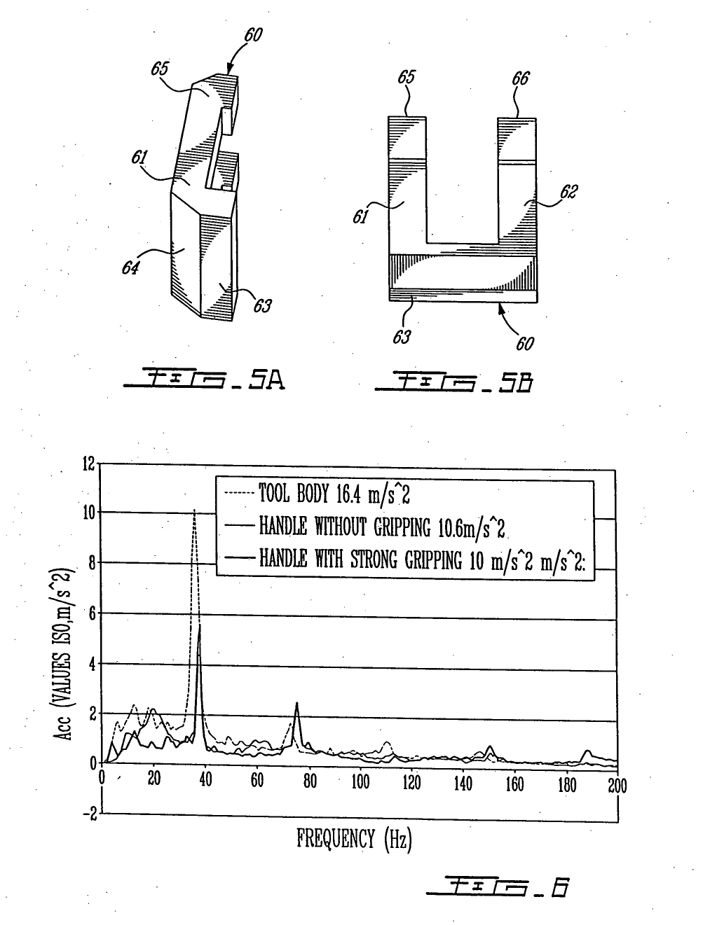

FIGS. 5a and 5b illustrates a resilient member 60 for use as resilient members 46 and 47 of FIG. 2. The resilient member 60 is L-shaped in cross section, defines two legs 61 and 62 and a shoulders 63, and is bevelled at 64. The shoulder 63 will, as explained in the foregoing description, keep the resilient member in place. The two legs 61 and 62 terminate in respective, thicker cushions 65 and 66. These cushions 65 and 66 keep the resilient member 60 compressed in the equilibrium position of the anti-vibratory handle 24 of FIG. 2. If the worker applies a significant pulling or pushing force on the anti-vibratory handle 24, the entire legs 61 and 62 are compressed between the box-like structure of the mobile portion 29 and the arm member 27 of the drill-mounted stationary portion 25. Under this condition, the suspension firms up and acts as a resilient bumper, limiting the pivoting movement of the anti-vibratory handle 24 about the shoulder screws 57 and 59. This concept provides at the same time good vibration insulation within the normal range of pulling and pushing forces applied to the anti-vibratory handle 24 and a still resilient bumper when an important pushing or pulling force is applied. It should be noted here that elastomers can withstand very heavy compression loads before showing permanent deformation.

It should be mentioned here that resilient members of other forms or nature can be used. For example, a torsion member can be used. This torsion member will be made of resilient material and interposed between the arm members 27 and 30. It is believed to be within the knowledge of those of ordinary skill in the art to design a torsional resilient member or other type of resilient member having the same function as the resilient members 46, 47 and 60.

In-situ tests were also conducted to evaluate the behaviour of the anti-vibratory handle according to the illustrative embodiment of the present invention, during use under normal conditions of drilling.

In addition to the anti-vibratory efficiency of the handle, the robustness of the concept and its impact on the overall ergonomic quality of the percussion drill were also evaluated.

All measurements were conducted on a JOY™ percussion drill under normal conditions at the 130 meter level of a laboratory mine. The results given hereinafter were obtained during actual drilling sessions.

A triaxial accelerometer connected to a data acquisition and processing system was used to measure and analyse the vibrations. The triaxial accelerometer was attached to the end of the hand-grip member with the base of the accelerometer located on a vertical axis on top of the handle, hence at the same level as the operator's hands in the normal working position.

Table 1 summarizes the acceleration values measured by the triaxial accelerometer on the hand-grip member to show the effect of the tested anti-vibratory handle (see FIGS. 2 and 3) on the vibrations produced at the level of the worker's hands. More specifically, Table 1 shows the attenuations obtained with the anti-vibratory handle along the x-axis, the y-axis and the z-axis. For example, in the axis of percussion (x-axis), the attenuation is greater than 50%. In the axes perpendicular to the axis of percussion (y-axis and z-axis), a slight increase of the vibrations is observed, due to rotation of the handle about the articulation. This results in a global reduction in vibrations of the order of 30%.

TABLE 1

| | x-axis | y-axis | z-axis | OVERALL |
|---|---|---|---|---|
| Conventional | 17.5 | 7.9 | 9.1 | 21.2 |
| handle | | | | |
| Anti-vibratory | 8.1 | 8.2 | 10 | 15.3 |
| handle | | | | |
| % attenuation | 53% | −4% | −11% | 28% |

Moreover, the spectrum illustrated in FIG. 6 clearly shows the vibration-attenuating effect of the anti-vibratory handle in the axis of percussion of the drill.

The anti-vibratory handle was used to drill more than 30 meters without showing any sign of weakness, thus demonstrating at the same time both the robustness and the reliability of the concept.

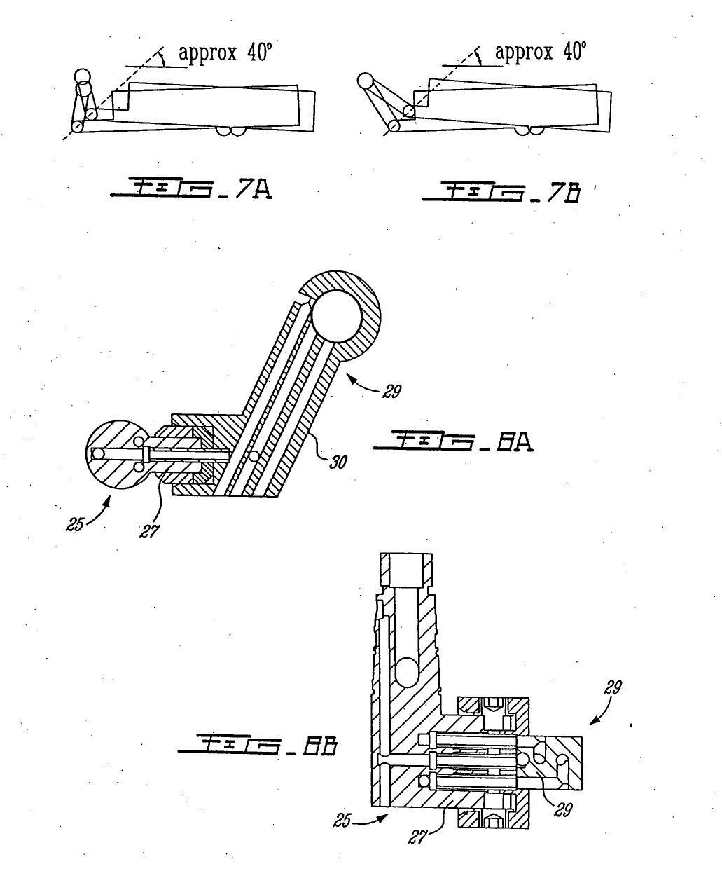

Analysis of high-speed filming showed that the movement of the handle attachment point is not parallel to the axis of percussion of the JOY™ drill but 40° apart from this axis of percussion as shown in FIGS. 7a and 7b. This is due to the center of gravity of the percussion drill not being situated in the axis of percussion, which brings about a slight rotational movement of the percussion drill about its point of attachment to the air-leg. FIGS. 7a and 7b show, in an amplified manner, the rotational movement of the percussion drill and the anti-vibratory handle.

FIG. 7a illustrates the situation for the case of the anti-vibratory handle 24 of FIGS. 2 and 3. This design has been optimized for a percussion drill in which the movement of the articulation 18 (FIG. 1) is parallel to the axis of percussion. Although this design is effective for a displacement of the articulation of the anti-vibratory handle parallel to the axis of percussion, it brings about a slight increase of the vibrations perpendicular to the axis of percussion. In order to address this problem, the solution illustrated in FIG. 7b was developed. By inclining the neutral position of the arm member 30 (FIG. 2) to an angle generally 90° apart from the direction of movement of the articularion 18, it is possible to compensate for the vibrations perpendicular to the axis of percussion.

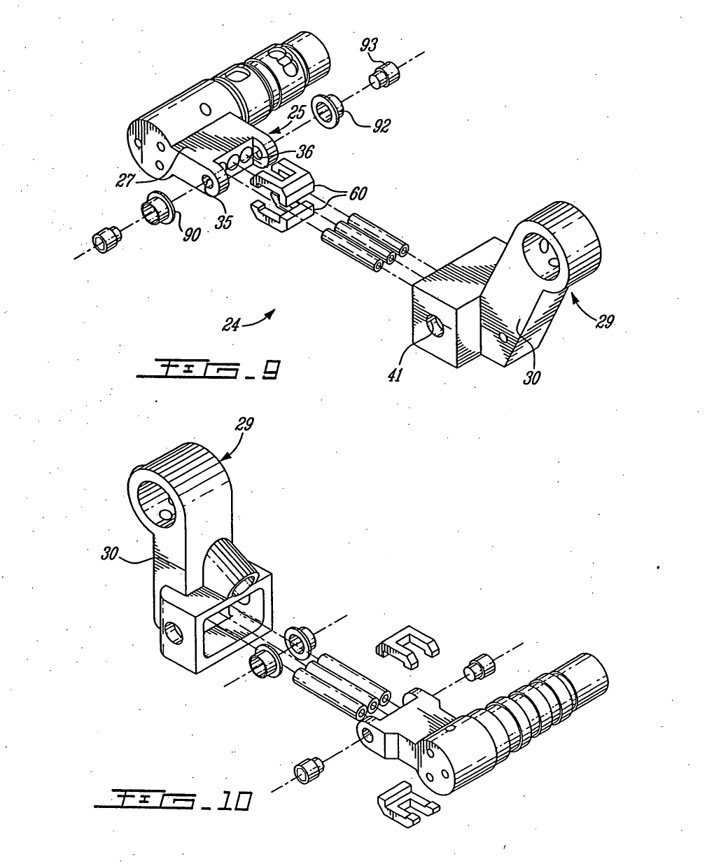

FIGS. 8a and 8b are cross sectional, side elevational and top plan views of the anti-vibratory handle 24 optimized for the JOY™ percussion drill, while FIG. 9 is an exploded, three-dimensional perspective view of this handle.

The differences between the anti-vibratory handle of FIGS. 8 and 9 with respect to the anti-vibratory handle of FIG. 2 are the following:

The neutral angle of the arm member 30 has been adjusted to absorb vertical as well as horizontal vibrations produced by a JOY™ percussion drill (see FIG. 7b).

The arm member 27 of the stationary portion 25 of the handle 24 is not only wider but has been shortened in order to position the hand-grip member of the anti-vibratory handle 24 at the same position as the hand-grip member of the original handle of the JOY™ percussion drill. The dimensions of the box-like structure of the mobile portion 29 of the anti-vibratory handle 24 has been modified to receive the modified arm member 27.

The anti-vibratory handle 24 of FIGS. 8 and 9 uses the resilient member of FIGS. 5a and 5b as resilient members 46 and 47 (FIG. 2).

Hole 41 is wider to receive a bushing 90 from the inside of the box-like structure of the mobile portion 29. An embedded screw 91 is driven into the threaded hole 35 through the bushing 90 to form a more robust pivot. Screw 91 is confined in hole 41 and does not protrude from wall 39 of the box-like structure of the mobile portion 29.

Hole 42 (FIG. 2) is wider to receive a bushing 92 from the inside of the box-like structure of the mobile portion 29. An embedded screw 93 is driven into the threaded hole 36 through the bushing 92 to form a more robust pivot. Screw 93 is confined in hole 42 and does not protrude from wall 40 (FIG. 9) of the box-like structure of the mobile portion 29.

The suspended mass of the mobile portion 29 has been increased by 720 grams (2930 g compared to 2210 g for the anti-vibratory handle 24 of FIG. 2), allowing for further reduction of the vibration levels;

Air ducts of wider diameter, allowing faster response of the air-leg.

The resulting anti-vibratory handle 24 of FIGS. 8 and 9 is easier to machine and possesses a greater robustness.

The attenuation of the vibrations perpendicular to the axis of percussion by anti-vibratory handle 24 of FIGS. 8 and 9 optimized for the JOY™ drill is estimated to about 50%. Maintaining the same performances along the two other axes would give an overall attenuation of 40%.

Increasing the suspended mass and machining precision for mass production would further increase the performances of the anti-vibratory handle 24, up to 50% attenuation overall along the three axes.

FIG. 10 illustrates an anti-vibratory handle 24 optimized for a SECAN™ percussion drill.

The main difference between the original handles of SECAN™ and JOY™ percussion drills is the presence of a push-button valve on the hand-grip member.

As it was the case for the JOY™ percussion drill, the angle of movement of the hand-grip member was examined using a high-speed camera in order to optimize the design by maximizing the absorption of vibrations perpendicular to the axis of percussion. In the case of the SECAN™ percussion drill, the angle of movement is smaller than for JOY™ percussion drills, having a value of about 15°.

The anti-vibratory handle of FIG. 10, optimized for SECAN™ percussion drills, presents the following differences with the anti-vibratory handle of FIGS. 8 and 9, optimized for JOY™ percussion drills:

The hand-grip portion of the air-leg quick retraction valve (it should be noted that the valve used is the same as for the original rigid handle).

The neutral angle of the arm member 30 is perpendicular to the 15° angle of movement of the SECAN™ percussion drill;

The suspended mass of the mobile portion 29 is the same as that of the anti-vibratory handle 24 of FIGS. 9 and 10.

The total added mass is 630 g.

The above described concept of anti-vibratory handle for percussion drills presents, amongst others, the following advantages:

Attenuation of the vibrations is nearly 50% in the axis of percussion and 30% overall.

No sign of apparent wearing of the anti-vibratory handle was detected after more than 30 m of drilling.

The impact of the suspension of the anti-vibratory handle on tool handling seems negligible. Comments from experienced workers indicate that the impact of the suspension on tool handling is negligible.

The new suspension can be directly installed on existing machines. The illustrative embodiment of anti-vibratory handle optimized for JOY™ drills adapts directly to the drill and involves the same control elements as those used on the original handle. The illustrative embodiment of anti-vibratory handle optimized for the SECAN™ drill allows this same ease of replacement. The work time necessary for a mechanic to install the anti-vibratory handle on an existing percussion drill is estimated at a few minutes.

Although the present invention has been described hereinabove by way of a non-restrictive illustrative embodiment thereof, this embodiment can be modified at will, within the scope of the appended claims, without departing from the nature and spirit of the subject invention. For example, it should be understood that the anti-vibratory handle according to the non-restrictive illustrative embodiment of the present invention can be optimized for every type of percussion drill or other tool producing vibrations.

1. An anti-vibratory handle for installation on a tool producing vibrations, comprising:
a stationary portion mounted on a body of the tool;
a mobile portion comprising a hand-grip member; and
an articulation between the stationary and mobile portions, the articulation comprising:
a pivot assembly interconnecting the stationary and mobile portions; and
a resilient vibration-damping assembly interposed between the stationary and mobile portions to restrict angular movement of the mobile portion on the pivot assembly about the stationary portion substantially within a given angular range.

2. An anti-vibratory handle as defined in claim 1, wherein:
the vibrations are produced by a reciprocating movement of the tool along a first axis; and
the pivot assembly defines a pivot axis substantially perpendicular to the first axis.

3. An anti-vibratory handle as defined in claim 2, wherein:
the hand grip member of the mobile portion is spaced apart from the pivot axis in a direction generally transverse to the first axis.

4. An anti-vibratory handle as defined in claim 1, wherein:
the vibrations produce a reciprocating movement of the body of the tool in a first direction;
the pivot assembly defines a pivot axis substantially perpendicular to the first direction; and
the hand grip member of the mobile portion is spaced apart from the pivot axis in a second direction generally perpendicular to the first direction.

5. An anti-vibratory handle as defined in claim 1, wherein:
the resilient vibration-damping assembly comprises a plurality of resilient members interposed between the stationary and mobile portions.

6. An anti-vibratory handle as defined in claim 1, wherein:
the resilient vibration-damping assembly comprises a resilient torsion member interposed between the stationary and mobile portions.

7. An anti-vibratory handle as defined in claim 2, wherein:
the stationary portion comprises a first arm member parallel to the first axis; and
the mobile portion comprises a second arm member angularly spaced apart from the first arm member.

8. An anti-vibratory handle as defined in claim 7, wherein, when the tool is not operating, the second arm member is spaced apart from the first arm member by an angle situated within the range of 75° to 130°.

9. An anti-vibratory handle as defined in claim 7, wherein:
the first arm member comprises a proximal end fixedly connected to the body of the tool, and a distal end forming part of the articulation; and
the second arm member comprises a proximal end forming part of the articulation and a distal end for receiving the hand-grip member.

10. An anti-vibratory handle as defined in claim 9, wherein the pivot assembly comprises:
first and second opposite side ears on the distal end of the first arm member, the first and second opposite side ears having respective coaxial threaded holes;
a hollow rectangular box-like structure on the proximal end of the second arm member, the hollow rectangular box-like structure having:
an open wall to receive the first and second opposite side ears on the distal end of the first arm member; and
first and second opposite side walls with respective coaxial holes;
a first bushing placed in the hole of the first side wall and a second bushing placed in the hole of the second side wall; and
a first screw driven in the threaded hole of the first ear through the first bushing, and a second screw driven in the threaded hole of the second ear through the second bushing.

11. An anti-vibratory handle as defined in claim 9, wherein:
the distal end of the first arm member comprises first and second opposite longitudinal flat faces generally parallel to the pivot axis;
the proximal end of the second arm member comprises a hollow rectangular box-like structure having:
an open wall to receive the distal end of the first arm member; and
first and second opposite walls generally parallel to the pivot axis and having respective inner faces;
the resilient vibration-damping assembly comprises:
a first resilient member between the first longitudinal flat face and the inner face of the first wall of the hollow rectangular box-like structure; and
a second resilient member between the second longitudinal flat face and the inner face of the second wall of the hollow rectangular box-like structure.

12. An anti-vibratory handle as defined in claim 11, wherein:
the distal end of the first arm member further comprises a third end flat face generally perpendicular to the first and second opposite longitudinal flat faces;
the hollow rectangular box-like structure further comprises a bottom wall generally perpendicular to the inner faces of the first and second opposite walls;
the first resilient member comprises a first shoulder placed between the third end flat face and the bottom wall; and
the second resilient member comprises a second shoulder placed between the third end flat face and the bottom wall.

13. An anti-vibratory handle as defined in claim 12, wherein:
the first resilient member comprises a pair of spaced apart parallel legs extending from the first shoulder between the first longitudinal flat face and the inner face of the first wall of the hollow rectangular box-like structure; and
the second resilient member comprises a pair of spaced apart parallel legs extending from the second shoulder between the second longitudinal flat face and the inner face of the second wall of the hollow rectangular box-like structure.

14. An anti-vibratory handle as defined in claim 13, wherein:
the pair of spaced apart parallel legs of the first resilient member each comprise a thicker free end section; and
the pair of spaced apart parallel legs of the second resilient member each comprise a thicker free end section.

15. An anti-vibratory handle as defined in claim 12, wherein:
the third end flat face comprises a plurality of holes;
the bottom wall of the hollow rectangular box-like structure comprises a plurality of holes; and
the anti-vibratory handle comprise a plurality of flexible air-transmission tubes having first ends respectively inserted in the holes in the third end flat face and second ends respectively inserted in the holes in the bottom wall of the hollow rectangular box-like structure;
wherein the tubes extend between the first and second shoulders of the first and second resilient members.

16. An anti-vibratory handle as defined in claim 5, wherein:
the resilient members are made of elastomeric material.

17. A method of installing an anti-vibratory handle on a tool producing vibrations, comprising:
mounting a stationary handle portion on a body of the tool;
connecting a mobile tool portion to the stationary tool portion through a pivot assembly, the mobile tool portion comprising a hand-grip member; and
interposing a resilient vibration-damping assembly between the stationary and mobile tool portions to restrict angular movement of the mobile tool portion on the pivot assembly about the stationary tool portion substantially within a given angular range.

18. A method of installing an anti-vibratory handle as defined in claim 17, wherein:
the vibrations are produced by a reciprocating movement of the tool along a first axis;
the method comprises orienting a pivot axis of the pivot assembly perpendicular to the first axis.

19. A method of installing an anti-vibratory handle as defined in claim 18, comprising:
spacing apart the hand grip member of the mobile portion from the pivot axis in a direction generally transverse to the first axis.

20. A method of installing an anti-vibratory handle as defined in claim 17, wherein:
the vibrations produce a reciprocating movement of the body of the tool in a first direction;
orienting a pivot axis of the pivot assembly substantially perpendicular to the first direction; and
spacing apart the hand grip member of the mobile portion from the pivot axis in a second direction generally perpendicular to the first direction.

21. A method of installing an anti-vibratory handle as defined in claim 17, wherein:
interposing a resilient vibration-damping assembly comprises interposing a plurality of resilient members between the stationary and mobile tool portions.
